(19) United States
(12) Patent Application Publication
(10) Pub. No.: US 2003/0132831 A1
(43) Pub. Date: Jul. 17, 2003

(54) Vehicle anti-theft key with transponder

(76) Inventors: David C. Banks, Johnson City, TN (US); Charles C. Edwards, Greenville, TN (US)

Correspondence Address: LUEDEKA, NEELY & GRAHAM, P.C., P O BOX 1871, KNOXVILLE, TN, 37901, US

(21) Appl. No.: 10/050,619

(22) Filed: Jan. 16, 2002

(51) Int. Cl. G05B 19/00

(52) U.S. Cl. 340/5.61

(57) ABSTRACT

The design of a vehicle anti-theft key with transponder enhances manufacturability and protects the transponder from damage due to mechanical shock. The key includes a shank, a transponder, a shuttle, and a head. A transponder recess formed in the shuttle is sized to tightly receive the transponder, and a shank recess formed in the shuttle is configured to receive one end of the key shank. The key is assembled by inserting the transponder in the transponder recess and the key shank in the shank recess. A key head is then positioned about the shuttle, transponder, and shank end, preferably by means of a polymeric molding process. The transponder recess and shank recess are configured to ensure proper positioning of the transponder and key shank in their respective recesses.

### 1. FIELD OF THE INVENTION

The present invention relates generally to keys for a lock. More particularly, the present invention relates to keys for a motor vehicle ignition system that is secured by an electronic interlock.

### 2. BACKGROUND OF THE INVENTION

To inhibit the unauthorized use of motor vehicles, various types of electronic interlocks have been developed and incorporated into the ignition system of the vehicle. One such system, commonly referred to as PATS (Passive Anti-Theft System), utilizes a transponder embedded in the ignition key. When the key is inserted in the ignition, the vehicle ignition system generates an electromagnetic field which energizes the transponder in the key. The transponder then transmits a coded wireless signal which is received by the vehicle ignition system and decoded. If the decoded signal meets the criteria for a valid signal, the vehicle ignition system allows the vehicle engine to be started. If the decoded signal is determined to be invalid, the vehicle ignition system will prevent the engine from being started.

A variety of manufacturing difficulties have surfaced in the production of PATS keys due to the difficulty associated with incorporating a transponder into the limited amount of space occupied by a key. For example, since the orientation of the transponder within the key is important to proper operation of the electronic interlock, the manufacturing method employed should ensure a consistently accurate placement of the transponder within the key. Some transponders are encased within a glass enclosure that is susceptible to damage when exposed to mechanical shock, so consideration should be given to ensuring the survivability of the transponder after is has been formed within the key. One prior art approach to protecting the transponder and increasing its operational reliability has been to wrap a shock absorbing sleeve around the glass encased transponder before molding the transponder into the key. However, this additional manufacturing procedure increases the cost of the key. Costs and ease of manufacturability are other factors which should be considered, particularly given the fact that such keys are typically mass produced. Unfortunately, prior art approaches associated with the design and manufacture of PATS keys have been less than optimal.

Therefore, there is a need for a PATS key design and associate method of manufacture that improves upon prior art approaches.

### SUMMARY OF THE INVENTION

The present invention eliminates the difficulties and disadvantages of the prior art by providing a key assembly which includes a key shank having a blade portion and a handle portion. A transponder is provided for receiving a wireless interrogation signal and for transmitting a wireless response signal in response to the interrogation signal. A shuttle is also provided. The shuttle includes first and second surfaces having substantially planar portions which are parallel to each other and separated by a distance greater than the thickness of the handle portion of the key shank. A shank recess formed in the shuttle includes a receiving end for receiving the handle portion of the key shank and a terminal end having an obstruction for limiting the depth that the handle portion is received in the shank recess. Also formed in the shuttle is a transponder recess with a receiving end for receiving the transponder and a terminal end having an obstruction for limiting the depth that the transponder is received in the transponder recess. A key head is integrally formed about the shuttle, transponder, and handle portion of the key shank.

The transponder may be any one of a variety of types and shapes. For example, in one embodiment the transponder is substantially cylindrical. In another embodiment, the transponder is substantially polyhedral.

The handle portion of the key shank may also be any one of a variety of shapes and configurations. In one embodiment, for example, the handle portion is offset from the remainder of the key shank so as to form a shoulder which is received by a corresponding ledge in the shank recess. In another embodiment, the handle portion includes two spaced apart legs which are received by a correspondingly configured shank recess.

The terminal end obstructions of the shank and transponder recesses may be provided by structurally closing off the terminal ends of the recesses. Alternatively, the terminal end obstructions may be effected with partial closure of the terminal ends of the recesses.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawings (which are not to scale) where:

FIG. 1 is a plan view of a vehicle anti-theft key having a transponder embedded near an outer portion of a key head in accordance with the invention;

FIG. 2 is an exploded view of the vehicle anti-theft key of FIG. 1;

FIG. 3 is a plan view of a vehicle anti-theft key having a transponder embedded near an inner portion of a key head in accordance with the invention;

FIG. 4 is an exploded view of the vehicle anti-theft key of FIG. 3;

FIG. 5 is an end view of a shuttle for use in a vehicle anti-theft key of the type shown in FIGS. 1 and 2;

FIG. 6 is an end view of a shuttle for use in a vehicle anti-theft key of the type shown in FIGS. 3 and 4;

FIG. 7 is another end view of the shuttle of FIG. 6; and

FIG. 8 is an end view of an alternate embodiment of the shuttle of FIG. 5.

### DETAILED DESCRIPTION OF THE PREFERRED EMBODIMENT(S)

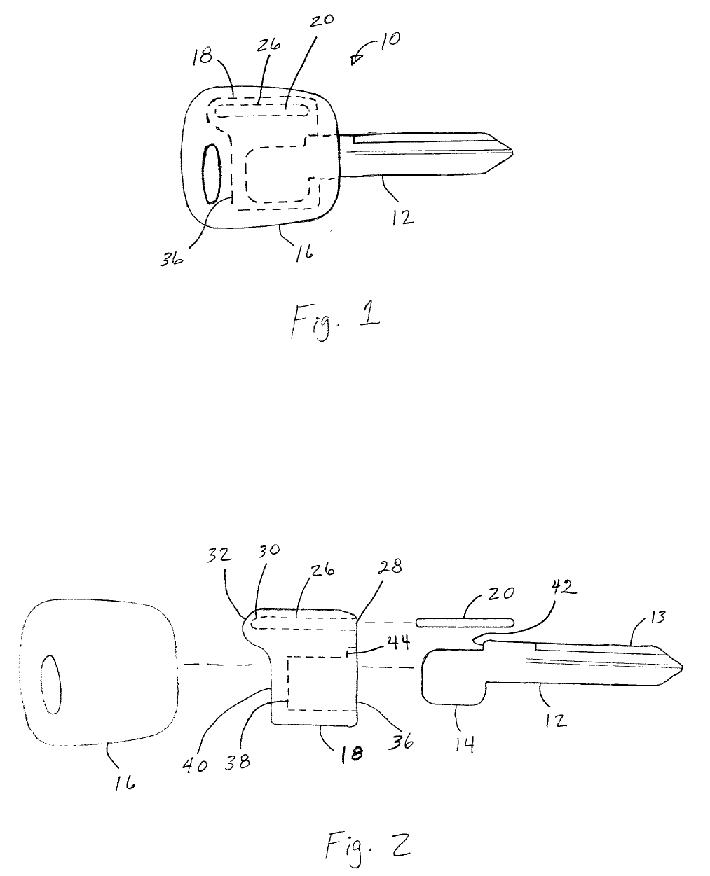

With reference now to the drawings in which like reference characters designate like or similar parts throughout the several views, FIGS. 1 and 2 illustrate a preferred embodiment of a vehicle anti-theft key 10 for use in a vehicle having an electronic interlock system in accordance with the present invention. An electronic interlock vehicle ignition system suitable for use with the key 10 is described in U.S. Pat. No. 5,433,096 entitled “Key Assembly For Vehicle Ignition Locks”, the entire contents of which are incorporated herein by reference.

For the embodiment of FIGS. 1 and 2, the key 10 includes a shank 12, a head 16, a shuttle 18, and a transponder 20. The shank 12 is further defined by a blade portion 13 and a handle portion 14. The shuttle 18, as further shown in FIG. 5, includes a first surface 22 in opposed relation to a second surface 24. Preferably, at least a portion of the surfaces 22, 24 are substantially planar and substantially parallel to one another. The two surfaces 22, 24 are separated by a distance that is at least as great as a dimension of the transponder 20 (such as the transponder diameter as in the case of the cylindrical transponder 20 as shown in FIGS. 1 and 2). The shuttle 18 may be fabricated from any suitable material, such as plastic.

A transponder recess 26 is provided in the shuttle 18. The transponder recess 26, which for the embodiment of FIGS. 1 and 2 has a circular dimension with a diameter slightly larger than the diameter of the transponder 20, is preferably sized to tightly contain the transponder 20 so as to inhibit movement of the transponder 20 within the recess 26 and reduce the likelihood of damage when the transponder is exposed to mechanical shock. A cylindrical transponder 20 such as that shown in FIG. 2 can be obtained from Texas Instruments under part number RI-TRP-BRHP-04. The recess 26 includes an insertion end 28 for receiving the transponder 20 into the recess 26 and a terminal end 30 having an obstruction 32 for limiting the depth that the transponder 20 is received into the recess 26. Although the terminal end 30 of the transponder recess 26 is shown in FIGS. 1 and 2 as being totally closed, it will be understood that the obstruction 32 can be provided in conjunction with a terminal end 30 that is at least partially open.

A shank recess 34 is also provided in the shuttle 18. In a preferred embodiment, the shank recess 34 has a rectangular dimension which closely approximates that of the key shank handle portion 14 and is preferably sized to tightly contain the key shank handle portion 14 so as to inhibit movement of the key shank 12 relative to the shuttle 18. The shank recess 34 includes an insertion end 36 for receiving the handle portion 14 of the key shank 12 and a terminal end 38 having an obstruction 40 for limiting the depth that the key shank handle portion 14 is received into the recess 34. Although the terminal end 38 is shown in FIGS. 1 and 2 as being totally enclosed, it will be understood that the obstruction 40 can be provided in conjunction with a terminal end 38 that is at least partially open.

In a preferred embodiment, the handle portion 14 of the key shank 12 is offset from the blade portion 13 of the key shank 12, forming a shoulder 42 adjacent the handle portion 14. For this embodiment, the shank recess 34 includes a corresponding ledge 44 for receiving the shoulder 42. Configuring the shank 12 and shank recess 34 in this manner helps ensure proper positioning of the handle portion 14 of the key shank 12 when the handle portion 14 is inserted into the shank recess 34.

The key 10 is assembled by positioning the transponder 20 in the transponder recess 26 and positioning the key shank handle portion 14 in the shank recess 34. The key head 16 is then positioned about the shuttle 18, transponder 20, and handle portion 14 as shown in FIG. 1. In a preferred embodiment, the key head 16 is integrally formed about the shuttle 18, transponder 20, and key shank handle portion 14 using a polymeric molding process. In a preferred polymeric molding process, the key head 16 is thermoformed by injection molding the key head 16 from a polymeric material (such as polyester or nylon) with the aid of a die. An alternative polymeric molding process utilizes a thermoset process of forming the key head 16 in place. Thus, it will be appreciated that the key 10 may be assembled in a highly efficient and effective manner.

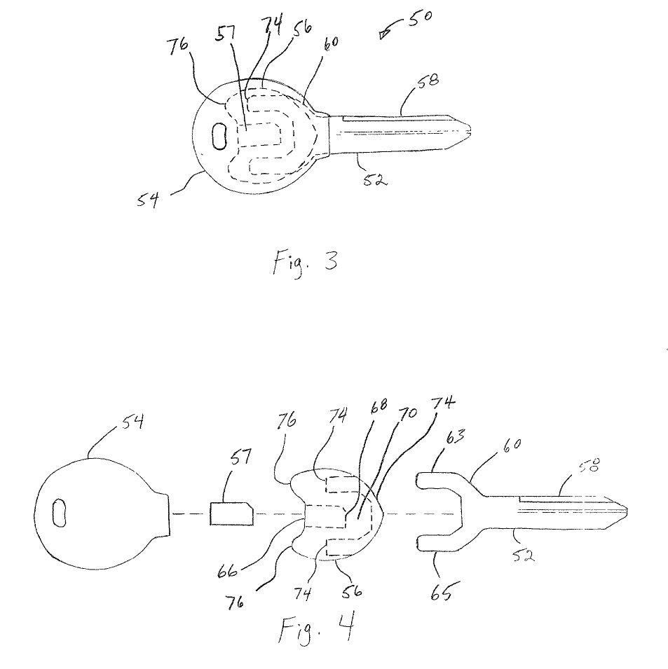

In an alternate embodiment of a vehicle anti-theft key shown in FIGS. 3 and 4, the key 50 includes a key shank 52, a head 54, a shuttle 56, and a transponder 57 packaged in a form similar to that of an integrated circuit chip. Such a transponder is available from Texas Instruments under part number RI-TRP-A9WK.

As shown in FIG. 4, the key shank 52 is defined by a blade portion 58 and a handle portion 60. The handle portion 60 is further defined by a pair of spaced apart legs 63, 65.

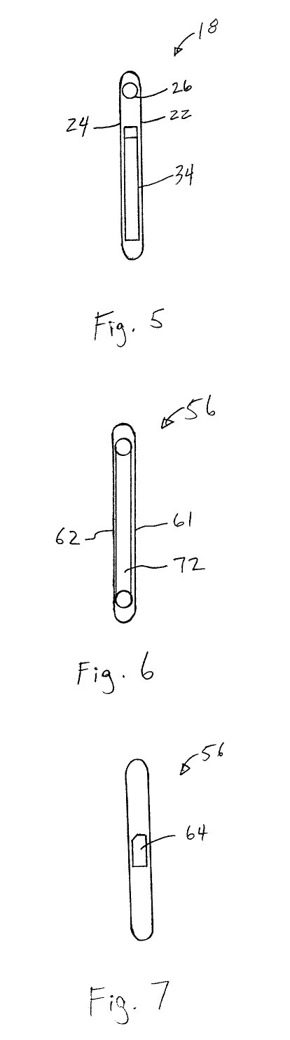

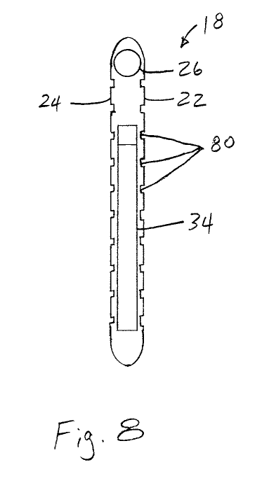

The shuttle 56, as further shown in FIGS. 6 and 7, includes a first surface 61 in opposed relation to a second surface 62. Preferably, at least a portion of the surfaces 61, 62 are substantially planar and substantially parallel to one another. The two surfaces 61, 62 are separated by a distance that is at least as great as a dimension of the transponder 57.

A transponder recess 64 is provided in the shuttle 56. The transponder recess 64, which for the embodiment of FIGS. 3 and 4 has a substantially polyhedral configuration slightly larger than that of the substantially polyhedral transponder 57, is preferably sized to tightly contain the transponder 57 so as to inhibit movement of the transponder 57 within the recess 64. The shape of the transponder recess 64 is preferably keyed to the shape of the transponder 57 so as to assure proper positioning of the transponder 57 in the recess 64. The recess 64 includes an insertion end 66 for receiving the transponder 57 into the recess 64 and a terminal end 68 having an obstruction 70 for limiting the depth that the transponder 57 is received into the recess 64. Although the terminal end 68 of the transponder recess 64 is shown in FIGS. 3 and 4 as being totally closed, it will be understood that the obstruction 70 can be provided in conjunction with a terminal end 68 that is at least partially open.

A shank recess 72 is also provided in the shuttle 56. In a preferred embodiment, the shank recess 72 is dimensioned to closely receive at least the two spaced apart legs 63, 65 of the key shank handle portion 60. The shank recess 72 is preferably sized to tightly contain the key shank handle portion 60 so as to inhibit movement of the key shank 52 relative to the shuttle 56. The shank recess 72 includes an insertion end 74 for receiving the handle portion 60 of the key shank 52 and a terminal end 74 having an obstruction 76 for limiting the depth that the key shank handle portion 60 is received into the recess 72. Although the terminal end 74 is shown in FIGS. 3 and 4 as being totally enclosed, it will be understood that the obstruction 76 can be provided in conjunction with a terminal end 74 that is at least partially open. The two spaced apart legs 63, 65 are substantially symmetrical to one another, which significantly reduces or eliminates the possibility for improper orientation of the handle portion 60 when inserted in the recess 72.

The key 50 is assembled by positioning the transponder 57 in the transponder recess 64 and positioning the key shank handle portion 60 in the shank recess 72. The key head 16 is then positioned about the shuttle 56, transponder 57, and handle portion 60 as shown in FIG. 3. In a preferred embodiment, the key head 54 is integrally formed about the shuttle 56, transponder 57, and key shank handle portion 60 using a polymeric molding process. In a preferred polymeric molding process, the key head 54 is thermoformed by injection molding the key head 54 from a polymeric material (such as polyester or nylon) with the aid of a die. An alternative polymeric molding process utilizes a thermoset process of forming the key head 54 in place. Thus, it will be appreciated that the key 50 may be assembled in a highly efficient and effective manner.

It will be appreciated that an anti-theft key assembly process in accordance with the invention described herein provides a highly efficient and effective way of mass producing the keys. Labor and material costs are significantly less than other methods previously employed.

While the invention has been described in detail, it is to be expressly understood that it will be apparent to persons skilled in the relevant art that the invention may be modified without departing from the spirit of the invention. For example, FIG. 7 illustrates how the shuttle 18 of FIG. 5 can be modified to include corrugations 80 at surfaces 22 and 24. The corrugations 80 are believed to enhance bonding of the head 16 when it is formed or positioned about the shuttle 18. As illustrated by this example, various changes of form, design or arrangement may be made to the invention without departing from the spirit and scope of the invention. Therefore, the above mentioned description is to be considered exemplary, rather than limiting, and the true scope of the invention is that defined in the following claims.

What is claimed is:

1. A key assembly comprising:
a key shank having a blade portion and a handle portion, said handle portion having a thickness;
a transponder for receiving a wireless interrogation signal and transmitting a wireless response signal in response to the interrogation signal;
a shuttle including:
a first surface having a substantially planar portion;
a second surface having a substantially planar portion parallel to the substantially planar portion of the first surface and separated therefrom by a substantially uniform distance greater that the thickness of the key shank handle portion;
a shank recess having a receiving end for receiving the handle portion of the key shank and a terminal end having an obstruction for limiting the depth that the handle portion is received in the shank recess; and
a transponder recess having a receiving end for receiving the transponder and a terminal end having an obstruction for limiting the depth that the transponder is received in the transponder recess; and
a key head integrally formed about said shuttle, transponder, and handle portion of the key shank.

2. The key assembly of claim 1 wherein said transponder is substantially cylindrical.

3. The key assembly of claim 1 wherein said transponder is substantially rectangular.

4. The key assembly of claim 1 wherein the terminal end of said shank recess is closed.

5. The key assembly of claim 1 wherein the terminal end of said transponder recess is closed.

6. The key assembly of claim 1 wherein the handle portion of said key shank is substantially rectangular.

7. The key assembly of claim 6 wherein the handle portion of the key shank is offset from the blade portion of the key shank, forming a shoulder adjacent the handle portion, said shank recess including a ledge for receiving the shoulder.

8. The key assembly of claim 1 wherein the handle portion includes two spaced apart legs, said shuttle including a single shank recess for receiving both legs.

9. The key assembly of claim 1 wherein said transponder recess is keyed to prevent improper orientation of the transponder in the transponder recess.

10. The key assembly of claim 1 wherein said first and second surfaces of the shuttle are corrugated.

11. A key assembly comprising:
a key shank having a blade portion and a handle portion, said handle portion having a thickness;
a transponder for receiving a wireless interrogation signal and transmitting a wireless response signal in response to the interrogation signal;
a shuttle including:
a first surface having a substantially planar portion;
a second surface having a substantially planar portion parallel to the substantially planar portion of the first surface and separated therefrom by a substantially uniform distance greater that the thickness of the key shank handle portion;
a shank recess having an open receiving end for receiving the handle portion of the key shank and a closed terminal end for limiting the depth that the handle portion is received in the shank recess; and
a transponder recess having an open receiving end for receiving the transponder and a closed terminal end for limiting the depth that the transponder is received in the transponder recess; and
a key head integrally formed about said shuttle, transponder, and handle portion of the key shank.

12. The key assembly of claim 11 wherein said transponder is substantially cylindrical.

13. The key assembly of claim 11 wherein said transponder is substantially rectangular.

14. The key assembly of claim 11 wherein the handle portion of the key shank is offset from the blade portion of the key shank, forming a shoulder adjacent the handle portion, said shank recess including a ledge for receiving the shoulder.

15. The key assembly of claim 11 wherein the handle portion includes two spaced apart legs, said shuttle including a single shank recess for receiving both legs.

16. The key assembly of claim 11 wherein said transponder recess is keyed to prevent improper orientation of the transponder in the transponder recess.

17. The key assembly of claim 11 wherein said first and second surfaces of the shuttle are corrugated.

18. A key assembly comprising:
a key shank having a blade portion and a handle portion offset from the blade portion to form a shoulder adjacent the handle portion, said handle portion having a thickness;
a transponder for receiving a wireless interrogation signal and transmitting a wireless response signal in response to the interrogation signal;
a shuttle including:
a first substantially planar surface;
a second substantially planar surface parallel to the first substantially planar surface and separated therefrom by a substantially uniform distance greater that the thickness of the key shank handle portion;
a shank recess having:
an open receiving end for receiving the handle portion of the key shank;
a terminal end in opposed relation to the open receiving end; and
a ledge for receiving the shoulder of the key shank handle portion for limiting the depth that the handle portion is received in the shank recess;
a transponder recess having an open receiving end for receiving the transponder and a terminal end; and
a key head integrally formed about said shuttle, transponder, and handle portion of the key shank.
